(19) United States
(12) Patent Application Publication
(10) Pub. No.: US 2023/0083367 A1
(43) Pub. Date: Mar. 16, 2023

(54) LIQUID MATERIAL APPLICATION UNIT, LIQUID MATERIAL APPLICATION DEVICE, AND LIQUID MATERIAL APPLICATION METHOD

(71) Applicant: NTN CORPORATION, Osaka (JP)

(72) Inventors: Kouhei KAMIYA, lwata-shi, Shizuoka (JP); Yuto OZEKI, lwata-shi, Shizuoka (JP); Mariko MORIYOSHI, Iwata-shi, Shizuoka (JP)

(21) Appl. No.: 17/910,737

(22) PCT Filed: Mar. 12, 2021
(86) PCT No.: PCT/JP2021/010078

§ 371 Date: Sep. 9, 2022

(30) Foreign Application Priority Data
Mar. 13, 2020 (JP) 2020-043983
Mar. 11, 2021 (JP) 2021-038988

(51) Int. Cl. B05C 5/02; B05D 1/26

(52) U.S. Cl. CPC B05C 5/0291; B05D 1/26

(57) ABSTRACT

A liquid material application unit includes an application needle and an application liquid container. The application liquid container includes a joining section and a needle movement section. The joining section extends in a horizontal direction. The needle movement section extends, in a vertical direction, from the joining section. A protrusion amount by which the application needle is allowed to protrude from a through-hole of the application liquid container in the vertical direction is greater than or equal to 1 mm and less than or equal to 3 mm. A first width of the needle movement section in the horizontal direction is less than or equal to 5 mm. A length of the needle movement section extending from the joining section to the through-hole in the vertical direction is greater than or equal to 5 mm.

### TECHNICAL FIELD

The present disclosure relates to a liquid material application unit, a liquid material application device, and a liquid material application method.

### BACKGROUND ART

During packaging of electronic components, a liquid material such as a conductive material or an adhesive is applied. The recent trend of downsizing of electronic components has required such a liquid material in a trace amount to be stably applied.

Further, for fixing a component such as a minute optical component using an adhesive, an adhesive composed of a liquid material that is a mixture of two liquids and cured by a chemical reaction is widely used. This is because a single-component moisture-curable adhesive takes time to be cured.

The process of applying the liquid material to an electronic component and the process of applying the liquid material adhesive composed of a mixture of two liquids are preferably performed using, for example, an application needle as disclosed in Japanese Patent Laying-Open No. 2007-268353, In this case, the liquid material in an application liquid container adheres to the application needle in the application liquid container. Subsequently, the application needle protrudes from a through-hole of the application liquid container, and the liquid material adhering to the application needle is transferred to an application object. The use of the application needle allows a fine pattern to be applied to liquid materials over a wide viscosity range.

### CITATION LIST

### Patent Literature

PTL 1: Japanese Patent Laying-Open No. 2007-268353

### SUMMARY OF INVENTION

### Technical Problem

For the application of the liquid material using the application needle, it is important to control a so-called protrusion amount, which is a distance by which the application needle protrudes from the application liquid container, That is, when the protrusion amount is excessively large, air bubbles may mix into the liquid material in the application liquid container, or the applied pattern may vary in application diameter. Further, when the protrusion amount is excessively small, the applied pattern may increase in application diameter.

The present disclosure has been made in view of the above-described problems. It is therefore an object of the present disclosure to provide a liquid material application unit, a liquid material application device, and a liquid material application method that can prevent air bubbles from mixing into a liquid material and stably supply a pattern having a minute application diameter.

### Solution to Problem

A liquid material application unit according to the present disclosure includes an application needle and an application liquid container. The application needle applies a liquid material. The application liquid container holds therein the liquid material and has a through-hole formed at a bottom portion, the through-hole allowing the application needle to pass through. The application liquid container includes a joining section and a needle movement section. The joining section extends in a horizontal direction intersecting an extending direction of the application needle. The needle movement section extends from the joining section to the through-hole in a vertical direction that coincides with the extending direction of the application needle. A protrusion amount by which the application needle is allowed to protrude from the through-hole of the application liquid container in the vertical direction is greater than or equal to 1 mm and less than or equal to 3 mm. A first width of the needle movement section in the horizontal direction is less than or equal to 5 mm. A length of the needle movement section extending from the joining section to the through-hole in the vertical direction is greater than or equal to 5 mm.

Under a liquid material application method according to the present disclosure, an application liquid container having a through-hole formed at a bottom portion is aligned over an application object of a liquid material with the liquid material held in the application liquid container and a distal end of an application needle immersed in the liquid material. The application liquid container is brought close to the application object. The application needle is moved in an extending direction of the application needle to apply the liquid material to the application object. In the above-described application process, a protrusion amount by which the application needle is allowed to protrude from the through-hole of the application liquid container in the extending direction is greater than or equal to 1 mm and less than or equal to 3 mm. In the above-described approaching process, the application liquid container is placed to be at least partly surrounded by the application object.

### Advantageous Effects of Invention

According to the present disclosure, the liquid material application unit, the liquid material application device, and the liquid material application method that can prevent air bubbles from mixing into a liquid material and stably supply a pattern having a minute application diameter can be provided.

### BRIEF DESCRIPTION OF DRAWINGS

FIG. 1 is a schematic perspective view of a liquid material application device according to the present embodiment.

FIG. 2 is a diagram schematically illustrating a configuration of a part of a liquid material application unit according to the present embodiment.

FIG. 3 is a schematic front view of the liquid material application unit according to the present embodiment, illustrating a first example of a configuration of the liquid material application unit.

FIG. 4 is a schematic side view of the liquid material application unit according to the present embodiment, illustrating the first example of the configuration of the liquid material application unit.

FIG. 5 is a schematic front and side view of the liquid material application unit according to the present embodiment, illustrating a second example of the configuration of the liquid material application unit.

FIG. 6 is a schematic front and side view of the liquid material application unit according to the present embodiment, illustrating a third example of the configuration of the liquid material application unit.

FIG. 7 is a schematic diagram for describing a cam member of an application mechanism illustrated in FIG. 6.

FIG. 8 is a schematic diagram for describing a liquid material application method using the liquid material application unit according to the present embodiment.

FIG. 9 is a schematic diagram for describing a liquid material application method using a liquid material application unit according to a comparative example.

FIG. 10 is a schematic diagram illustrating an application process with an application needle protruding by a normal amount.

FIG. 11 is a schematic diagram illustrating an application process with the application needle protruding by an extremely small amount, given for comparison with FIG. 10.

FIG. 12 is a graph showing test results of variations in application diameter with the protrusion amount set at 3 mm.

FIG. 13 is a graph showing test results of variations in application diameter with the protrusion amount set at 15 mm.

FIG. 14 is a schematic diagram illustrating an initial position, in a vertical direction, of the application needle in an application liquid container.

FIG. 15 is a schematic diagram for describing a gap position.

FIG. 16 is a schematic cross-sectional view taken along a line XVI-XVI in 15.

FIG. 17 is a schematic diagram illustrating how air bubbles mix in in a manner that depends on an application interval.

FIG. 18 is a flowchart of a liquid material application method according to a third working example.

### DESCRIPTION OF EMBODIMENTS

Hereinafter, the present embodiment will be described with reference to the drawings.

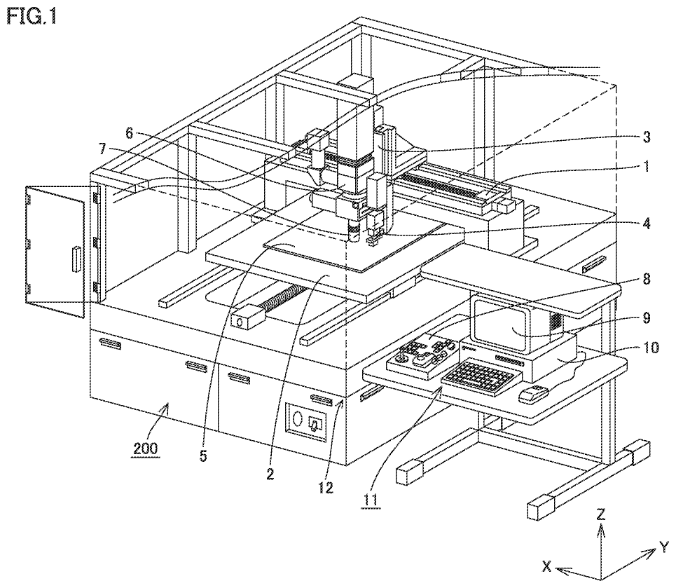

FIG. 1 is a schematic perspective view of a liquid material application device according to the present embodiment. With reference to FIG. 1, a liquid material application device 200 according to the present embodiment includes a base 12 disposed on a floor surface, an X-axis table 1, a Y-axis table 2, a Z-axis table 3, a liquid material application unit 4, an observation optical system 6, a CCD camera 7 connected to observation optical system 6, and a controller 11.

Y-axis table 2 movable in a Y-axis direction in FIG. 1 is installed on an upper surface of base 12. Specifically, Y-axis table 2 has a guide section installed on a lower surface of Y-axis table 2 and is slidably connected with and along a guide rail installed on the upper surface of base 12. Y-axis table 2 further has a ball screw connected to the lower surface of Y-axis table 2. Y-axis table 2 is movable along the guide rail (in the Y-axis direction) by the ball screw operated with a driving member such as a motor. An upper surface portion of Y-axis table 2 serves as a placement surface on which an application object 5 is placed. Note that FIG. 1 illustrates a thin plate substrate as application object 5. This is, however, merely an example, and application object 5 may be, for example, a bottom portion of a groove as described later.

On base 12, a gate-shaped structure installed across the guide rail of Y-axis table 2 in an X-axis direction is provided. X-axis table 1 movable in the X-axis direction is placed on the structure. For example, a ball screw makes X-axis table 1 movable in the X-axis direction.

Z-axis table 3 is placed on a movable body of X-axis table 1, and liquid material application unit 4 and observation optical system 6 are placed on Z-axis table 3. Liquid material application unit 4 and observation optical system 6 are movable in the X direction together with Z-axis table 3. Liquid material application unit 4 is provided to apply an application liquid to an application surface (upper surface) of application object 5 using an application needle provided in liquid material application unit 4. Observation optical system 6 is provided to observe an application position of application object 5. CCD camera 7 of observation optical system 6 converts an observed image into an electrical signal, Z-axis table 3 supports liquid material application unit 4 and observation optical system 6 movable in a Z-axis direction.

Controller 11 includes a control panel 8, a monitor 9, and a control computer 10, and controls X-axis table 1, Y-axis table 2, Z-axis table 3, liquid material application unit 4, and observation optical system 6. Control panel 8 is used to input a command to control computer 10. Monitor 9 displays image data obtained by conversion made by CCD camera. 7 of observation optical system 6 and data output from control computer 10.

When a circuit pattern is drawn on application object 5, a drawing start position is determined by moving a drawing position of application object 5 directly below observation optical system 6 with X-axis table 1 and Y-axis table 2, and observing and confirming the drawing start position with observation optical system 6. Then, the circuit pattern is drawn from the drawing start position thus determined. From the drawing start position, application object 5 is moved, step-by-step, by X-axis table 1 and Y-axis table 2 so as to make the drawing position immediately below liquid material application unit 4. When the movement is completed, liquid material application unit 4 is driven to perform application. Continuously repeating the above processing makes it possible to draw the circuit pattern.

A relationship between a descent end position of an application needle 24 and a focus position of observation optical system 6 is stored in advance, and during drawing, the application is performed after moving application needle 24 in the Z-axis direction with the Z-axis table to a height at which application needle 24 comes into contact with application object 5 with a position where the focus of observation optical system 6 is on an image as a reference in the Z-axis direction. When an area of the circuit pattern to be drawn is large, and the height of the application position of application object 5 greatly varies during the drawing, the focus position is checked as needed during the drawing, and the application is performed after the position in the Z-axis direction is corrected. At this time; the focus position may be adjusted by an autofocus method using image processing, or a method by which the height position of the surface of application object 5 to be applied is constantly detected with a laser sensor or the like, and correction is performed in real time.

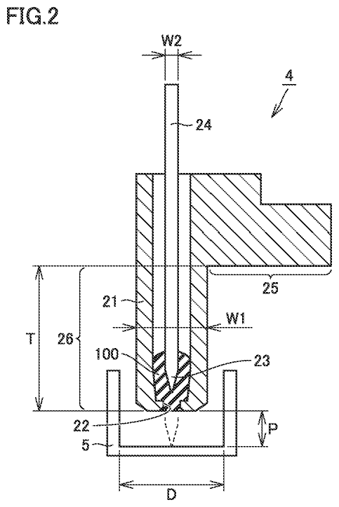

Next, liquid material application unit 4 according to the present embodiment will be described in detail with reference to FIGS. 2 to 7.

FIG. 2 is a diagram schematically illustrating a configuration of a part of the liquid material application unit according to the present embodiment. With reference to FIG. 2, liquid material application unit 4 according to the present embodiment includes an application liquid container 21 and application needle 24. Application liquid container 21 holds a liquid material 100 therein. Application liquid container 21 has a through-hole 22 formed at a bottom portion, which is the lowermost portion in FIG. 2. Application needle 24 is disposed in application liquid container 21 so as to be able to pass through application liquid container 21.

Application needle 24 applies liquid material 100 held in application liquid container 21. In FIG. 2, a distal end 23, which is the lowermost portion of application needle 24, is immersed in liquid material 100. When application needle 24 moves down, at least distal end 23 passes through through-hole 22 to protrude from through-hole 22. This causes application needle 24 to apply liquid material 100 to the application object.

Application liquid container 21 includes a joining section 25 and a needle movement section 26. As described later, liquid material application unit 4 includes a drive unit such as a linear motion mechanism and a servomotor. Joining section 25 is a section where main members of liquid material application unit 4 such as the linear motion mechanism and application liquid container 21 are joined together. In the state illustrated in FIG. 2 where application needle 24 is allowed to pass through application liquid container 21 from through-hole 22, joining section 25 extends in a horizontal direction (left-right direction in FIG. 2) intersecting an extending direction (vertical direction in FIG. 2) of application needle 24 passing through application liquid container 21. On the other hand, needle movement section 26 is a section extending from joining section 25 to through-hole 22 in the vertical direction (Z direction in FIG. 1) that coincides with the extending direction of application needle 24. In other words, needle movement section 26 is a section disposed below joining section 25 and extending in the vertical direction below joining section 25 in FIG. 2. Application needle 24 moves in the vertical direction inside needle movement section 26.

A protrusion amount P by which application needle 24 is allowed to protrude from through-hole 22 of application liquid container 21 in the vertical direction in FIG. 2 is greater than or equal to 1 mm and less than or equal to 3 mm. That is, when application needle 24 illustrated in FIG. 2 moves down for applying liquid material 100 to application object 5, protrusion amount P as the distance by which distal end 23 protrudes downward from through-hole 22 is greater than or equal to 1 mm and less than or equal to 3 mm. A state where distal end 23 protrudes downward from through-hole 22 is represented by a dotted line in FIG. 2, Note that protrusion amount P may be greater than or equal to 1.5 mm and less than or equal to 3 mm, and more preferably greater than or equal to 2 mm and less than or equal to 3 mm. Protrusion amount P is more preferably greater than or equal to 2.5 mm and less than or equal to 3 mm. As an example, protrusion amount P is 3 mm.

A first width W1 of needle movement section 26 in the left-right direction in FIG. 2 is less than or equal to 5 mm. That is, for example, when needle movement section 26 is viewed from above in FIG. 2, the maximum width of an outer periphery in the horizontal direction is less than or equal to 5 mm. As an example, W1 is 5 mm. When the lowermost portion of needle movement section in 26 in FIG. 2 has a tapered shape, first width W1 indicates the maximum width of an outer periphery, in the horizontal direction, of a region where the maximum width of the outer periphery is substantially uniform in the vertical direction, other than the region having the tapered shape.

A length T of needle movement section 26 extending from joining section 25 to through-hole 22 in the vertical direction in FIG. 2 is greater than or equal to 5 mm. That is, needle movement section 26 extends downward from the lowermost portion of joining section 25 by at least 5 mm. As an example, T is 15 mm.

In liquid material application unit 4 having the above-described characteristics, first width W1 is less than or equal to five times a second width W2, in the left-right direction in FIG. 2, a section of application needle 24 extending in the vertical direction in FIG. 2. Here, the portion of application needle 24 extending in the vertical direction in FIG. 2 corresponds to a region where the maximum width of the outer periphery is substantially uniform in the vertical direction, other than a region such as distal end 23 in FIG. 2 that is inclined as a result of taper machining or the like. That is, in the region having second width W2 of application needle 24, the outer periphery of application needle 24 extends straight in the vertical direction and has a uniform outer peripheral width. Second width W2 means the maximum width of the outer periphery in the horizontal direction when application needle 24 is viewed from above in FIG. 2, for example. As an example, W1 is 5 mm, and W2 is 1 mm.

As illustrated in FIG. 2, application object 5 preferably has, fir example, a groove shape, a recessed shape, or a container shape having a side surface portion capable of surrounding application needle 24 when application needle 24 moves down and a bottom surface portion that is located below the side surface portion and to which liquid material 100 is applied. A lateral distance D across the processed side surface portion of application object 5 surrounding application needle 24 is, for example, greater than or equal to 6.5 mm, and may be 12 mm or 17 mm.

Liquid material 100 may be a conductive material used for, for example, mounting a crystal oscillator. Alternatively, liquid material 100 may be a catalytic material that is applied to a so-called micro electro mechanical systems (MEMS) gas sensor. Alternatively, liquid material 100 may be an adhesive that is applied to a light emitting diode (LED). Liquid material 100 may be a mixture of two liquids.

Liquid material 100 may be a liquid having fine particles suspended therein. For example, when liquid material 100 is an adhesive, reinforcing particles for the adhesive may be contained as fine particles. Liquid material 100 is not limited to a pure liquid containing no particles, and may be a liquid containing particles. Specifically, liquid material 100 may be a conductive paste containing metal particles for industrial use. In this case, the fine particles are metal particles. Liquid material 100 may be an adhesive containing inorganic particles. In this case, the fine particles are inorganic particles.

Note that a good balance between surface tension across the edge of through-hole 22 and pressure applied by the weight of liquid material 100 in application liquid container 21 prevents liquid material 100 in application liquid container 21 from leaking out through through-hole 22.

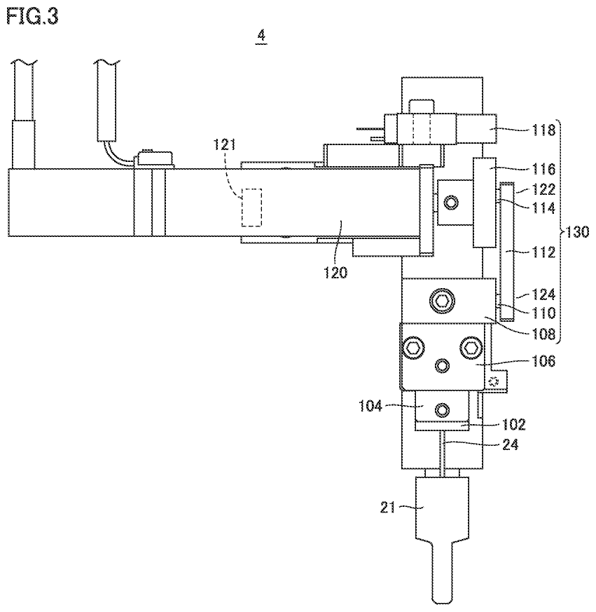

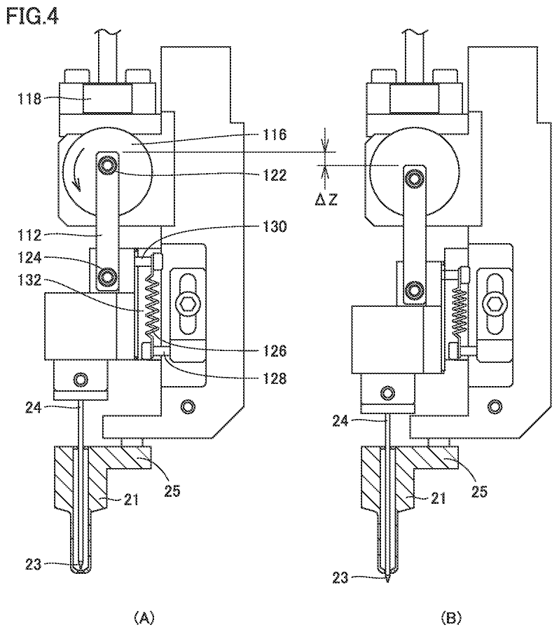

FIG. 3 is a schematic front view of the liquid material application unit according to the present embodiment, illustrating a first example of the configuration of the liquid material application unit. FIG. 4 is a schematic side view of the liquid material application unit according to the present embodiment, illustrating the first example of the configuration of the liquid material application unit. With reference to FIGS. 3 and 4, liquid material application unit 4 includes a servomotor 120, a motor driver 121, an application needle holder 102, an application needle holder housing 104, an application needle holder fixing section 106, and a linear motion mechanism 130, in addition to application liquid container 21 illustrated in FIG. 2.

Servomotor 120 is provided as a drive source for moving application needle 24 up and down. Application needle holder 102 holds one application needle 24 having a tapered tip. Linear motion mechanism 130 moves application needle holder 102 up and down in response to rotation of servomotor 120. Motor driver 121 controls the rotation of servomotor 120 so as to move application needle holder 102 up and down at an appropriate speed.

Linear motion mechanism 130 includes an origin sensor 118, an eccentric plate 116, an eccentric shaft 114, a linear guide 132, a coupling plate 112, a movable section 108, a coupling shaft 110, and bearings 122, 124.

Eccentric plate 116 is rotated by servomotor 120 and attached to a rotation shaft of servomotor 120 extending orthogonal to a vertical movement direction of application needle holder 102. Eccentric plate 116 is provided with eccentric shaft 114 at a position eccentric from the rotation shaft of servomotor 120.

Origin sensor 118 detects an origin defined on eccentric plate 116 and outputs the origin to motor driver 121. This origin is closest to origin sensor 118 when eccentric plate 116 coincides with a reference rotation angle.

In movable section 108, application needle holder 102 is attached to application needle holder fixing section 106, and one application needle 24 is held with distal end 23 facing downward from the lower surface of application needle holder 102. Linear guide 132 supports movable section 108 to which application needle holder 102 is fixed movable in the vertical direction.

Coupling plate 112 couples coupling shaft 110 provided in movable section 108 that moves up and down together with application needle holder 102 and eccentric shaft 114 with a fixed length.

Bearing 122 supports coupling plate 112 rotatable about eccentric shaft 114. Bearing 124 supports coupling plate 112 rotatable about coupling shaft 110.

Movable section 108 is attracted toward a fixing pin 128 via a spring 126 to prevent vibrations from being generated due to looseness of hearings 122, 124 during driving. Applying a preload to bearings 122, 124 to eliminate looseness allows a configuration without spring 126.

When servomotor 120 is driven to rotate eccentric plate 116, application needle 24 reciprocates in the vertical direction in response to the movement of eccentric shaft 114 in the vertical direction. When eccentric plate 116 rotates in one direction, coupling shaft 110 moves up and down by a vertical movement stroke AZ. That is, application needle 24 moves in the vertical direction in needle movement section 26 illustrated in FIG. 2. This causes distal end 23 of application needle 24 to repeatedly apply liquid material 100 and retract into liquid material 100 after the application.

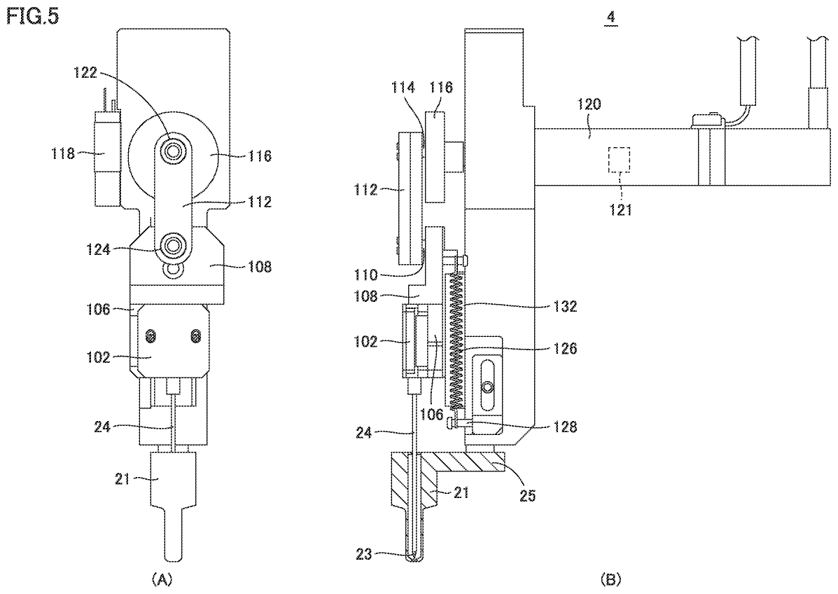

FIG. 5 is a schematic front and side view of the liquid material application unit according to the present embodiment, illustrating a second example of the configuration of the liquid material application unit. That is, (A) of FIG. 5 is a schematic front view, and (B) of FIG. 5 is a schematic side view. With reference to FIG. 5, the second example is basically die same in configuration as the first example illustrated in FIGS. 3 and 4, and thus no detailed description will be given below. Note that, as in the second example illustrated in FIG. 5, the extending direction of joining section 25 of application liquid container 21 may substantially coincide with the left-right direction in which servomotor 120 extends. Alternatively, as in the first example illustrated in FIGS. 3 and 4, the extending direction of joining section 25 of application liquid container 21 may intersect (for example, substantially orthogonal to) the left-right direction in which servomotor 120 extends. Note that liquid material application unit 4 illustrated in FIGS. 3 to 5 converts the rotation of servomotor 120 into a linear motion to move application needle 24 up and down. The configuration, however, is not limited to such an example. For example, as a mechanism for causing application needle 24 to linearly, reciprocate illustrated in FIGS. 3 to 5, any one selected from the group consisting of an electric linear motion actuator using a screw, an air cylinder using air pressure, and a solenoid may be used.

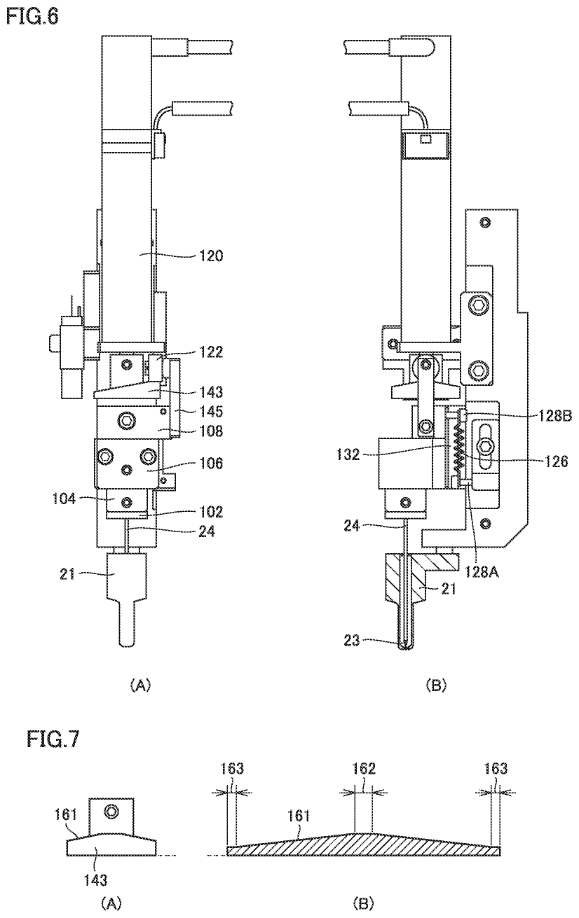

FIG. 6 is a schematic front and side view of the liquid material application unit according to the present embodiment, illustrating a third example of the configuration of the liquid material application unit. That is, (A) of FIG. 6 is a schematic front view, and (B) of FIG. 6 is a schematic side view. FIG. 7 is a schematic diagram for describing a cam member of an application mechanism illustrated in FIG. 6. With reference to FIGS. 6 and 7, liquid material application unit 4 of the third example mainly includes servomotor 120, a cam 143, bearing 122, a cam coupling plate 145, movable section 108, and application needle holder 102, in addition to application liquid container 21 illustrated in FIG. 2. Application needle holder 102 holds application needle 24. Servomotor 120 is installed with its rotation shaft extending in the Z-axis direction illustrated in FIG. 1. Cam 143 is connected to the rotation shaft of servomotor 120. Cam 143 is rotatable about the rotation shaft of servomotor 120.

Cam 143 includes a center section connected to the rotation shaft of servomotor 120 and a flange section connected to one end of the center section. As illustrated in (A) of FIG. 7, an upper surface (surface adjacent to servomotor 120) of the flange section is a cam surface 161. Cam surface 161 is formed in an annular shape along an outer periphery of the center section, and is formed in a slope shape so as to cause a distance from a bottom surface of the flange section to vary. Specifically, as illustrated in (B) of FIG. 7, cam surface 161 includes an upper end flat region 162 having the largest distance from the bottom surface of the flange section, a lower end flat region 163 disposed apart from the upper end flat region 162 and having the smallest distance from the bottom surface of the flange section, and a slope section connecting upper end flat region 162 and lower end flat region 163. Here, (B) of FIG. 7 is a developed view of the flange section including cam surface 161 disposed to surround the center section as viewed from a side.

Bearing 122 is disposed in contact with earn surface 161 of cam 143. As illustrated in (A) of FIG. 6, bearing 122 is disposed adjacent to a specific side (right side of servomotor 120) as viewed from cam 143 and is kept in contact with cam surface 161 when cam 143 rotates in response to the rotation of the rotation shaft of servomotor 120. Cam coupling plate 145 is connected to bearing 122. Cam coupling plate 145 has one end connected to bearing 122 and the other end fixed to movable section 108. Application needle holder fixing section 106 and application needle holder housing 104 are connected to movable section 108. Application needle holder housing 104 houses application needle holder 102.

Application needle holder 102 includes application needle 24. Application needle 24 is disposed so as to protrude from the lower surface (the lower side remote from the side where servomotor 120 is located) of application needle holder 102.

Application liquid container 21 is disposed below application needle holder 102. Application needle 24 is held with application needle 24 put into application liquid container 21.

Movable section 108 is provided with a fixing pin 128B. Further, a frame holding servomotor 120 is provided with a different fixing pin 128A. Spring 126 is installed so as to connect fixing pins 128A, 128B. Spring 126 applies, to movable section 108, a pulling force toward application liquid container 21. Further, the pulling force of spring 126 acts on bearing 122 via movable section 108 and cam coupling plate 145. This pulling force of spring 126 keeps bearing 122 pressed against earn surface 161 of cam 143.

Further, movable section 108, application needle holder fixing section 106, and application needle holder housing 104 are connected to linear guide 132 installed on the above-described frame. Linear guide 132 is disposed extending in the Z-axis direction. This makes movable section 108, application needle holder fixing section 106, and application needle holder housing 104 movable in the Z-axis direction.

Next, a description will be given of how liquid material application unit 4 described above operates. In liquid material application unit 4 described above, servomotor 120 is driven to rotate the rotation shaft of servomotor 120, thereby rotating cam 143. This causes cam surface 161 of cam 143 to change in height in the Z-axis direction, so that the position, in the Z-axis direction, of bearing 122 in contact with cam surface 161 on the right side of cam 143 illustrated in (A) of FIG. 6 also changes in response to the rotation of a drive shaft of servomotor 120.

Then, movable section 108, application needle holder fixing section 106, and application needle holder housing 104 move in the Z-axis direction in response to the change in position of bearing 122 in the Z-axis direction. This also causes application needle holder 102 held in application needle holder housing 104 to move in the Z-axis direction, thereby allowing a change in the position, in the Z-axis direction, of application needle 24 installed in application needle holder 102.

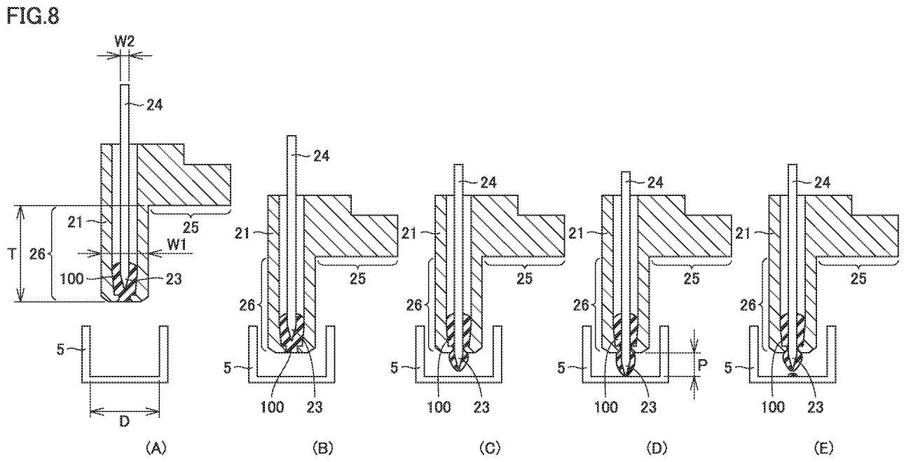

Next, a liquid material application method using liquid material application unit 4 according to the present embodiment will be described with reference to FIG. 8.

FIG. 8 is a schematic diagram for describing the liquid material application method using the liquid material application unit according to the present embodiment. Under the liquid material application method illustrated in FIG. 8, a process is performed in the order of (A), (B), (C), (D), and (E). With reference to FIG. 8, first, as illustrated in (A), liquid material 100 is held inside application liquid container 21 of liquid material application unit 4 having through-hole 22 formed at the lowermost portion (bottom portion). Application liquid container 21 illustrated in FIG. 8 is substantially the same in shape and size as application liquid container 21 illustrated in FIG. 2. At least distal end 23 of application needle 24 is immersed in liquid material 100. The region of application needle 24 immersed in liquid material 100 may include a part of a region located above distal end 23 illustrated in FIG. 8 and linearly extending with the uniform outer peripheral width. In this state, application liquid container 21 is aligned over, in the vertical direction in FIG. 8, the bottom surface of application object 5 such as a groove-shaped member or a recessed member to which liquid material 100 is applied.

Next, as illustrated in (B), application liquid container 21 is brought close to application object 5. Specifically, application liquid container 21 moves down. This causes needle movement section 26 of application liquid container 21 to be at least partially surrounded by the side surface portion of application object 5. In other words, needle movement section 26 partially enters the recessed portion of application object 5 so as to overlap the side surface portion of application object 5 in the horizontal direction. In other words, needle movement section 26 partially enters the recessed portion of application object 5 so as to make the side surface portion of application object 5 and needle movement section 26 identical in position in the vertical direction to each other.

Next, as illustrated in (C), application needle 24 is moved in the extending direction of application needle 24, that is, in the vertical direction. That is, as illustrated in (C), application needle 24 is moved down to bring distal end 23 close to the bottom surface portion of application object 5. This causes, as illustrated in (D), liquid material 100 adhering to, for example, distal end 23 of application needle 24 to be applied to the bottom surface portion of application object 5 or the like. Note that, at this time, application needle 24 may move down until distal end 23 comes into contact with application object 5 as illustrated in (D). Alternatively, application needle 24 may move down until liquid material 100 adhering to application needle 24 comes into contact with application object 5 without bringing distal end 23 into contact with application object 5. At this time, the protrusion amount by which application needle 24 is allowed to protrude from through-hole 22 located at the lowermost portion of application liquid container 21 in the vertical direction that coincides with the extending direction of application needle 24 is greater than or equal to 1 mm and less than or equal to 3 mm.

After the application, application needle 24 moves up as illustrated in (E). This causes distal end 23 to retract again into application liquid container 21. During the application process, it is preferable that the reciprocating motion including the movement (C), (D) of application needle 24 toward application object 5 in the extending direction of application needle 24 and the movement (E) of application needle 24 away from application object 5 be repeated nine times or less per second. This allows liquid material 100 to be suitably applied.

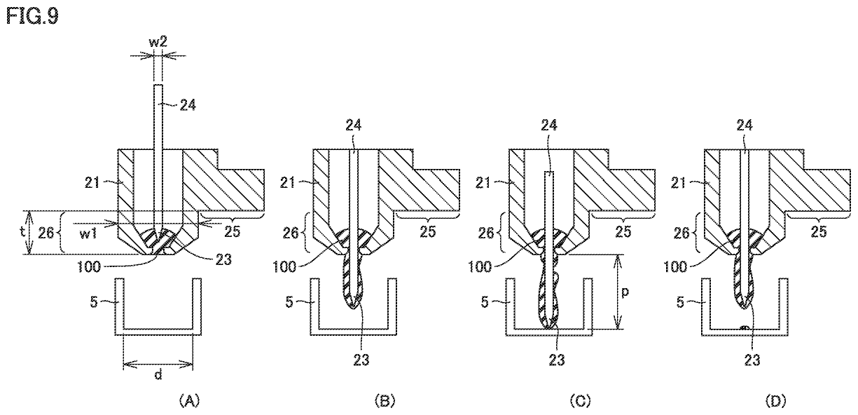

Next, a description will be given, with reference, as needed, to FIGS. 9 to 11, of actions and effects of the present embodiment in comparison with a comparative example.

FIG. 9 is a schematic diagram for describing a liquid material application method using a liquid material application unit according to the comparative example. In FIG. 9, a process is performed in the order of (A), (B), (C), and (D). With reference to FIG. 9, an application liquid container 21 according to the comparative example is, as illustrated in (A), lamer in first width w1 of needle movement section 26 and shorter in length tin the vertical direction than application liquid container 21 according to the present embodiment. First width tial is larger than a lateral distance d across the side surface portion of application object 5. First width w1 is greater than five times second width w2. This makes application liquid container 21 according to the comparative example unable to move down to the position where needle movement section 26 is surrounded by application object 5. Therefore, as illustrated in (B), with application liquid container 21 unchanged in position in the vertical direction, only application needle 24 moves down to protrude from application liquid container 21. Then, liquid material 100 is applied to application object 5 as illustrated in (C), and application needle 24 moves up as illustrated in (D).

Since application liquid container 21 does not move down as illustrated in FIG. 9, it is necessary to increase a protrusion amount p of application needle 24 as compared with the present embodiment illustrated in FIG. 8. An increase in protrusion amount p of application needle 24 (for example, 15 mm), however, will cause the following problem.

First, when application needle 24 moves up after the application of liquid material 100 illustrated in (D) of FIG. 9, air bubbles may mix into liquid material 100 in application liquid container 21. This is because of the following reason. As illustrated in (B), (C) of FIG. 9, liquid material 100 nonuniformly adheres to the portion of application needle 24 that is exposed when application needle 24 moves down. That is, on the outer periphery of application needle 24, a region to which liquid material 100 adheres and a region to which no liquid material 100 adheres alternately, appear in the extending direction. Such nonuniform adhesion is caused by a gap between application needle 24 and application liquid container 21 in a region close to through-hole 22 when liquid material 100 is pulled by application needle 24 when application needle 24 moves down. When a portion of the side surface of application needle 24 to which no liquid material 100 adheres returns into application liquid container 21 as illustrated in (D) of FIG. 9, air bubbles are likely to mix into liquid material 100 in application liquid container 21. The larger protrusion amount p of application needle 24, the larger the number of regions where liquid material 100 adheres and regions where no liquid material 100 adheres that alternately appear, Therefore, when protrusion amount p increases, the possibility that air bubbles mix in increases accordingly.

Further, the region where liquid material 100 nonuniformly adheres causes an increase in variation in application diameter of liquid material 100 to application object 5. Here, the application diameter means the maximum value of the dimension of applied liquid material 100 as viewed from above (for example, the length of the major axis of an ellipse), in other words, the diameter of a virtual circle circumscribing liquid material 100. This may make the planar shape of the pattern formed of liquid material 100 uneven.

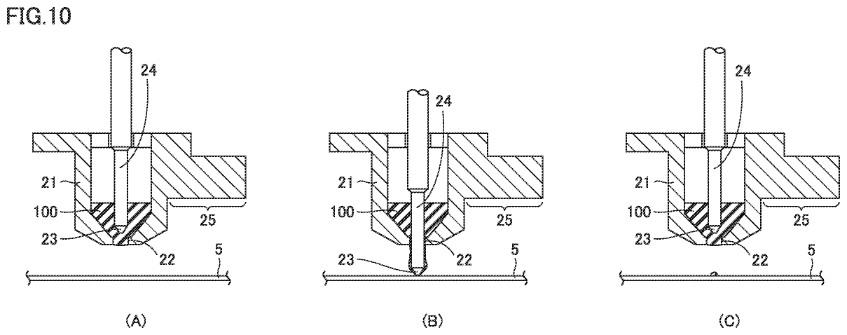

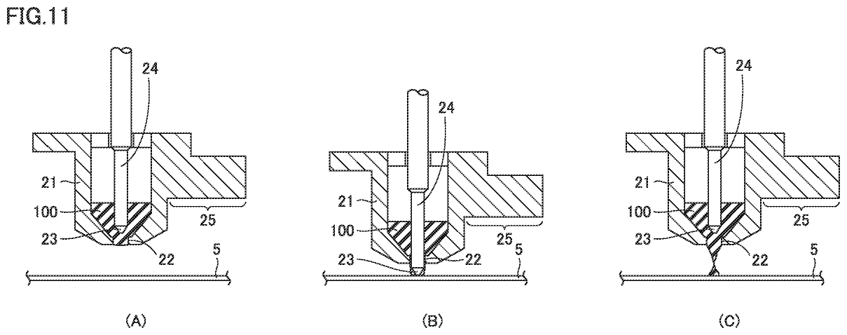

On the other hand, when protrusion amount p in FIG. 9 is extremely small (for example, less than 1 mm), another problem described below may occur. FIG. 10 is a schematic diagram illustrating an application process with the application needle protruding by a normal amount. FIG. 11 is a schematic diagram illustrating an application process with the application needle protruding by an extremely small amount, given for comparison with FIG. 10. In FIGS. 10 and 11, the process is performed in the order of (A), (B), and (C), where (A) illustrates a standby state before application, (B) illustrates an application state, and (C) illustrates a retracted state after application. With reference to FIGS. 10 and 11 for comparison, in the case of FIG. 11 where the protrusion amount of application needle 24 from through-hole 22 located at the bottom portion of application liquid container 21 is small, the application diameter of liquid material 100 to be transferred to the application object becomes excessively large as compared with FIG. 10 in which the protrusion amount is nominal. This is because, in FIG. 11, distal end 23 of application needle 24 reaches application object 5 immediately after being exposed from through-hole 22, so that the amount of liquid material 100 adhering to distal end 23 when distal end 23 is exposed from through-hole 22 becomes excessively large.

In view of the above-described problem of the comparative example, liquid material application unit 4 according to the present embodiment includes application needle 24 and application liquid container 21. Application needle 24 applies liquid material 100. Application liquid container 21 holds therein liquid material 100 and has through-hole 22 formed at the bottom portion, the through-hole 22 allowing application needle 24 to pass through. Application liquid container 21 includes joining section 25 and needle movement section 26. Joining section 25 extends in the horizontal direction intersecting the extending direction of application needle 24. Needle movement section 26 extends from joining section 25 to through-hole 22 in the vertical direction that coincides with the extending direction of application needle 24. Protrusion amount P by which application needle 24 is allowed to protrude from through-hole 22 of application liquid container 21 in the vertical direction is greater than or equal to 1 mm and less than or equal to 3 mm. First width W1 of needle movement section 26 in the horizontal direction is less than or equal to 5 mm. The length of needle movement section 26 extending from joining section 25 to through-hole 22 in the vertical direction is greater than or equal to 5 mm.

Liquid material application unit 4 described above and liquid material application device 200 including liquid material application unit 4 can drastically reduce air bubbles mixing into liquid material 100 in application liquid container 21 by setting the protrusion amount at a suitable small amount, specifically, less than or equal to 3 mm. The number of regions of the side surface of application needle 24 where liquid material 100 adheres and regions where no liquid material 100 adheres that alternately appear as illustrated in (D) of FIG. 9 decreases. This reduces the possibility that air generated by the gap between the regions where no liquid material 100 adheres and the wall portion of through-hole 22 is caught in application liquid container 21 when application needle 24 moves up. Therefore, the above-described effects can be obtained.

Further, setting the protrusion amount less than or equal to 3 mm, which is suitably short, makes it possible to reduce variations in application diameter of liquid material 100 and to transfer a pattern having a uniform application diameter. The number of regions of the side surface of application needle 24 where liquid material 100 adheres and regions where no liquid material 100 adheres that alternately appear as illustrated in (D) of FIG. 9 decreases. This is because the influence of liquid material 100 nonuniformly adhering on the transferred pattern of liquid material 100 is reduced.

Further, setting the protrusion amount less than or equal to 3 mm, which is suitably short, makes it possible to reduce the application time. This is because the time required for application needle 24 to protrude (move down) and retreat (move up) becomes short due to the small protrusion amount as compared with a case where the protrusion amount is large. This allows even highly volatile liquid material 100 to be quickly and stably applied.

Further, setting the protrusion amount less than or equal to 3 mm, which is suitably short, makes it possible to reduce a loss of liquid material 100. It is difficult to use liquid material 100 nonuniformly adhering to the side surface of application needle 24 for subsequent transfer to application object 5. Therefore, reducing the protrusion amount and the amount of liquid material 100 nonuniformly adhering makes it possible to reduce the amount of liquid material 100 that is not used for transfer.

The effect of suitably reducing the protrusion amount can be obtained by setting the first width of needle movement section 26 in the horizontal direction less than or equal to 5 mm and setting the length of needle movement section 26 extending from joining section 25 in the vertical direction greater than or equal to 5 mm. Accordingly, when application object 5 has a groove shape or a recessed shape, needle movement section 26 can be placed to be surrounded by the side surface portion of application object 5, and application liquid container 21 can be brought close to the bottom surface portion of application object 5. That is, needle movement section 26 is at least partly inserted to fit into the side surface portion, such as a groove shape, of application object 5. This can make the distance between the bottom surface portion of application object 5 and the lowermost portion of needle movement section 26 equal to a length suitable for application. Note that length T of needle movement section 26 in the vertical direction is more preferably greater than or equal to 5 mm as described above. Length T, however, only needs to be greater than at least a dimension obtained by subtracting protrusion amount P (for example, 3 mm) of application needle 24 from the depth of the side surface portion of application object 5 in the vertical direction. Accordingly, the above-described effects can be obtained.

Further, setting the protrusion amount greater than or equal to 1 mm, which is suitably long, makes it possible to reduce the amount of liquid material 100 adhering to distal end 23 of application needle 24 and allows a fine pattern to be applied.

The characteristics such as the shape and size of application liquid container 21 of liquid material application unit 4 according to the present embodiment are particularly effective when liquid material 100 is transferred to the bottom surface portion located at the bottom of the side surface portion of application object 5 having a groove shape or a recessed shape.

In liquid material application unit 4 descried above, first width W1 is preferably less than or equal to five times second width W2, in the horizontal direction, the portion of application needle 24 extending in the vertical direction. Accordingly, the same effects as described above can be obtained.

The liquid material application method according to the present embodiment includes the following processes. Application liquid container 21 having through-hole 22 formed at the bottom portion is aligned over application object 5 of liquid material 100 with liquid material 100 held in application liquid container 21 and distal end 23 of application needle 24 immersed in liquid material 100. Application liquid container 21 is brought close to application object 5. Application needle 24 is moved in the extending direction of application needle 24 to apply liquid material 100 to application object 5. In the above-described application process, protrusion amount P by which application needle 24 is allowed to protrude from through-hole 22 of application liquid container 21 in the extending direction is greater than or equal to 1 mm and less than or equal to 3 mm. In the above-described approaching process, application liquid container 21 is placed to be at least partly surrounded by application object 5. Accordingly, the same effects as described above can be obtained.

For the liquid material application method, liquid material 100 is preferably a liquid having fine particles suspended therein. Liquid material 100 containing fine particles has poor elasticity and easily breaks, so that nonuniform adhesion to the side surface of application needle 24 as illustrated in (B) to (D) of FIG. 9 is likely to occur. Liquid material application method according to the present embodiment is particularly effective in a case where such a liquid material 100 is used can produce the same actions and effect as described above.

For the liquid material application method, the viscosity of the liquid material is preferably less than or equal to 13.10 Pa's. When liquid material 100 is excessively high in viscosity, it is difficult to separate liquid material 100 located between application needle 24 and application object 5 at the start of ascending after application due to a large amount of liquid material 100 adhering to distal end 23 of application needle 24. Lowering the viscosity as described above can reduce the possibility of the occurrence of such a problem.

### First Working Example

A test to weigh air-bubble mixing ratios with protrusion amount P variously changed was conducted. Examinations were conducted on a case where protrusion amount P of application needle 24 from application liquid container 21 was set at 15 mm and a case where protrusion amount P was set at 3 mm. Liquid material 100 is a polymer solution. As liquid material 100, three types of a liquid material having a viscosity of 0.45 Pa·s (denoted as “A”), a liquid material having a viscosity of 1.95 Pa·s (denoted as “B”), and a liquid material having a viscosity of 13.10 Pa·s (denoted as “C”) were used. 48 samples were prepared for each type, and the same test was conducted on each sample.

The following Table 1 shows test results in a case where, as application needle 24, an application needle in which distal end 23 is not tapered, and a cross section intersecting the extending direction has a circular shape with first width W1 equal to 1000 μm (hereinafter, referred to as a “first application needle”) was used.

TABLE 1

| | Protrusion amount: | | | Protrusion amount: | | |
|---|---|---|---|---|---|---|
| | 15 mm | | | 3 mm | | |
| Number of samples | 48 | 48 | 48 | 48 | 48 | 48 |
| Number of mixing air | 0 | 14 | 24 | 0 | 0 | 0 |
| bubbles | | | | | | |
| Air-bubble mixing | 0% | 29.1% | 50% | 0% | 0% | 0% |
| ratio | | | | | | |

Further, the following Table 2 shows test results in a case where, as application needle 24, an application needle in which a portion other than distal end 23 has a circular shape with first width W1 equal to 1000 μm as described above, distal end 23 is tapered, and a cross section of the lowermost portion intersecting the extending direction has a circular shape with an outer peripheral diameter (corresponding to W1 described above) equal to 800 μm (hereinafter, referred to as a “second application needle”) was used.

TABLE 2

| | Protrusion amount: | | | Protrusion amount: | | |
|---|---|---|---|---|---|---|
| | 15 mm | | | 3 mm | | |
| Number of samples | 48 | 48 | 48 | 48 | 48 | 48 |
| Number of mixing air | 0 | 15 | 23 | 0 | 0 | 0 |
| bubbles | | | | | | |
| Air-bubble mixing | 0% | 31 2% | 47.9% | 0% | 0% | 0% |
| ratio | | | | | | |

From Tables 1 and 2, regardless of the type of application needle 24, air bubbles mixed in with high probability when protrusion amount P was 15 mm, whereas air bubbles were completely prevented front mixing in when protrusion amount P was 3 mm. The higher the viscosity of liquid material 100, the higher the air-bubble mixing ratio when protrusion amount is 15 mm. On the other hand, when protrusion amount was 3 mm, air bubbles did not mix in at all even with the example of 13.10 Pa·s that is the highest viscosity. From this, when the viscosity was less than or equal to 13.10 Pa·s, air bubbles were completely prevented from mixing in with protrusion amount set at 3 mm.

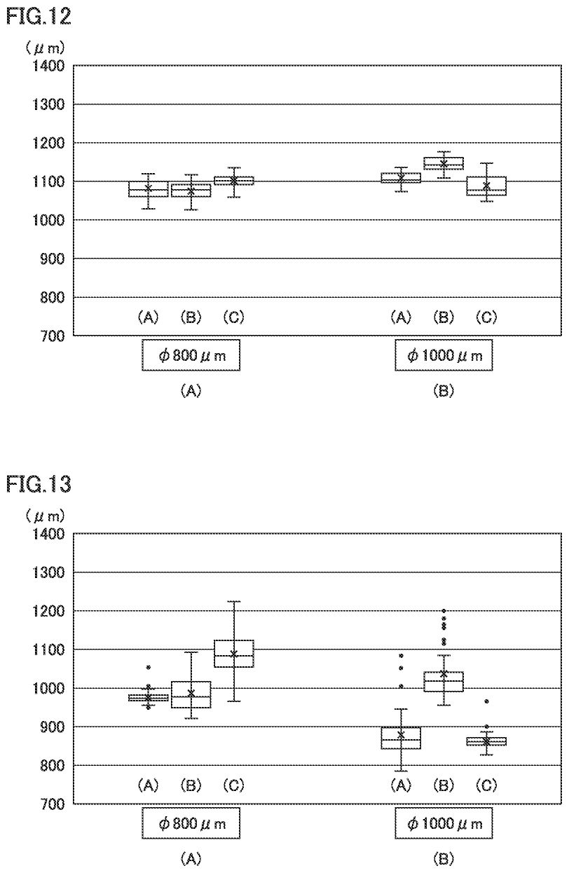

Further, in the above-described tests, examinations were conducted on variations in application diameter of liquid material 100. FIG. 12 is a graph showing test results of variations in application diameter with the protrusion amount set at 3 mm. FIG. 13 is a graph showing test results of variations in application diameter with the protrusion amount set at 15 mm. In each drawing, “Φ800 μm” indicates results of the second application needle, and “Φ1000 μm” indicates results of the first application needle. Calculation results of the coefficient of variation (3σ/Ave.) obtained from FIGS. 12 and 13 are shown in the following Table 3.

TABLE 3

| | Protrusion amount: | | | Protrusion amount: | | |
|---|---|---|---|---|---|---|
| | 15 mm | | | 3 mm | | |
| | (1) | (2) | (3) | (1) | (2) | (3) |
| φ 800 μm | 4.9 | 14.0 | 13.7 | 7.0 | 6.3 | 4.6 |
| φ 1000 μm | 19.7 | 18.6 | 10.0 | 4.4 | 5.1 | 8.6 |

With reference to FIG. 12, FIG. 13, and Table 3, the following results were obtained. When protrusion amount was 1.5 mm, the coefficient of variation varied among liquid materials 100 different in viscosity, that is, among A, B, and C, and also varied among liquid materials 100 the same in viscosity. Further, the absolute value of the coefficient of variation increased when protrusion amount was 15 mm. On the other hand, when protrusion amount was 3 mm, variations in the coefficient of variation were small among liquid materials 100 different in viscosity, that is, among A, B, and C, and variations were also small among liquid materials 100 the same in viscosity. Further, variations in the coefficient of variation were small when protrusion amount was 3 mm. There was no clear difference between the case where the first application needle is used and the case where the second application needle is used.

As described above, setting the protrusion amount at 3 mm makes variations in the application diameter small as compared with the case where protrusion amount is 15 mm. This is presumably because setting the protrusion amount at 3 mm makes variations in the application amount of liquid material 100 adhering to the side surface of application needle 24 small as compared with the case where protrusion amount is 15 mm, and liquid material 100 can be stably applied accordingly.

### Second Working Example

As described above, reducing protrusion amount P (see FIG. 2) of application needle 24 from through-hole 22 of application liquid container 21 in the application process makes it possible to reduce the number of air bubbles mixing into liquid material 100 in application liquid container 21. This allows a pattern having a minute application diameter to be stably supplied.

However, when the amount of liquid material 100 in application liquid container 21 is small, air bubbles may mix into liquid material 100 in application liquid container 21. This is presumably because when application needle 24 moves up to retract into application liquid container 21, the tip of application needle 24 (the lowermost portion of distal end 23) is separated upward from the liquid level of liquid material 100 in application liquid container 21, and the tip of application needle 24 catches air when application needle 24 moves down again. This may reduce, even in an early stage of the application process in which the amount of liquid material 100 in application liquid container 21 has not been significantly reduced, the use efficiency of liquid material 100 because air bubbles mixing into liquid material 100 prevents liquid material 100 from being sufficiently applied. In the present working example, a result of examining a method for adjusting the configuration of the liquid material application unit against the cause of the mixing of air bubbles will be described. In the following description, the liquid level of liquid material 100 means, unless otherwise specified, a liquid level (uppermost portion of liquid material 100) on the upper side of liquid material 100 in the vertical direction.

With a liquid material the same in viscosity as liquid material “C” having a viscosity of 13.10 Pa's according to the first working example, whether air bubbles mix in while changing the initial position of application needle 24 in the vertical direction relative to the position, in the vertical direction, of the liquid level of liquid material 100 in application liquid container 21 was examined. The following Table 4 shows examination results. Note that the initial position of application needle 24 means a first vertical position of application needle 24 before application needle 24 starts to move down to perform the application process (initial state).

TABLE 4

| | 0.5 mm | | 0.5 mm |
|---|---|---|---|
| | below the | Height of | above |
| | liquid level | liquid level | liquid level |
| Number of samples | 24 | 24 | 24 |
| Number of mixing air bubbles | 0 | 8 | 23 |
| Air-bubble mixing ratio | 0% | 33% | 96% |

Table 4 shows that when the tip of application needle 24 is placed above the liquid level of liquid material 100 in the initial state, that is, when application needle 24 is not immersed in liquid material 100 at all, air bubbles are likely to be generated in liquid material 100. It is therefore necessary to set the initial position of application needle 24 so as to position the tip of application needle 24 as low as possible relative to the liquid level of liquid material 100. In particular, when the amount of liquid material 100 is small, and the liquid level is lowered, it is important to adjust the initial position of application needle 24.

FIG. 14 is a schematic diagram illustrating the initial position, in the vertical direction, of the application needle in the application liquid container. With reference to FIG. 14, application needle 24 includes distal end 23 inclined, as illustrated in FIG. 14, as a result of taper machining or the like, and a uniform width region 24a other than distal end 23. Uniform width region 24a is a region that is located above distal end 23 and where the maximum width of the outer periphery is substantially uniform in the vertical direction. The maximum width of the outer periphery of uniform width region 24a is W2.

An inner wall 21a of application liquid container 21 has a tapered shape on a lower side in which the dimension of inner wall 21a in the left-right direction in the drawing, that is, the area of the cross section in the horizontal direction, is smaller than the dimension on an upper side. The initial position of application needle 24 is a position, in the vertical direction, of the tip of application needle 24 relative to a lowermost portion O of through-hole 22 of application liquid container 21, and is denoted as a distance P₀. Distance P₀ is set larger than a length t, in the vertical direction, of through-hole 22 located at the lower portion of application liquid container 21. When application needle 24 is retracted into application liquid container 21, liquid material 100 flows around and into a region adjacent to the tip of application needle 24 (a region immediately below the tip of application needle 24) in application liquid container 21.

When distance P₀ in the vertical direction between the lowermost portion of through-hole 22 and the tip of application needle 24 is small at the initial position of application needle 24, it is, however, difficult for liquid material 100 to flow into the region adjacent to the tip of application needle 24, and the time required for the inflow becomes longer. As the time required for the inflow becomes longer, a so-called “application interval” is set longer, and the takt time of the application process of causing application needle 24 to apply liquid material 100 becomes longer. Accordingly, the initial position of application needle 24, that is, the above-described distance P₀, is empirically set larger than length t of through-hole 22 in the vertical direction. The design criterion for distance P₀, however, was not clear. Therefore, in the present working example, a method by which the initial position (distance P₀) of application needle 24 can be made as short as possible by controlling a void ratio at a “gap position”, and the tip of application needle 24 can be positioned as low as possible relative to the liquid level of liquid material 100 was examined. Specifically, a method by which the initial position of the lowermost portion of distal end 23 of application needle 24 is set at a position where distal end 23 is placed in liquid material 100 and is covered with liquid material 100 was examined. A case where distance P₀ is smaller than t will be also examined below.

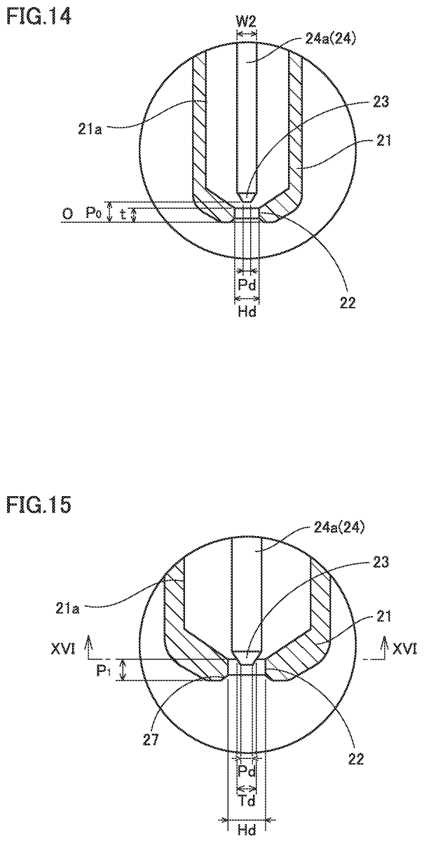

FIG. 15 is a schematic diagram for describing the gap position. With reference to FIG. 15, a gap position P₁ is a position at which the distance between application needle 24 and particularly the inner wall of through-hole 22 of application liquid container 21 in the left-right direction (horizontal direction) in FIG. 15 intersecting the extending direction of application needle 24 is the smallest among the initial positions of application needle 24 in the vertical direction in the initial state. Here, application needle 24 located at gap position P₁ may be distal end 23 having the outer periphery formed into a tapered shape. Gap position P₁ is defined in a region of the lowermost portion of through-hole 22 above a region where a C surface 27 is formed in FIG. 15. Normally, as illustrated in FIG. 15, the distance in the left-right direction between the outer periphery of distal end 23 of application needle 24 and the wall surface of through-hole 22 surrounding the outer periphery from the side is smaller than the distance in the left-right direction in the other regions. In this case, gap position P₁ is located at the uppermost portion of through-hole 22. This is because the outer periphery of distal end 23 of application needle 24 gradually increases along the tapered shape from the tip, and a tip diameter Td of application needle 24 at gap position P₁ is larger than a diameter Pd of the tip of application needle 24 (note that diameter Td is smaller than a diameter Hd of through-hole 22). In the region above through-hole 22, the dimension in the left-right direction of inner wall 21a of application liquid container 21 is significantly larger than the dimension in the left-right direction of through-hole 22. Therefore, in the region above the through-hole 22, the distance between the outer periphery of distal end 23 and inner wall 21a of application liquid container 21 does not become minimum. Therefore, the position where diameter Td becomes maximum just beside through-hole 22 is usually the uppermost portion of the through-hole 22. Note that, in FIG. 15, distal end 23 is placed at a position of the uppermost portion of through-hole 22 in the vertical direction, or alternatively, uniform width region 24a may be placed at the position.

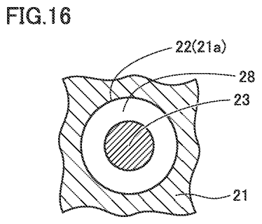

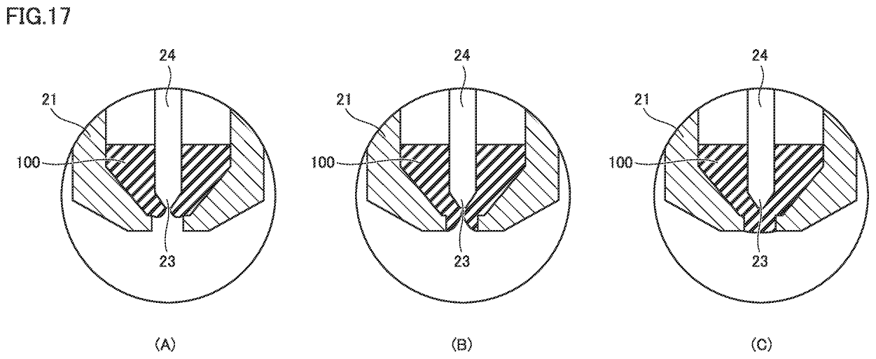

FIG. 16 is a schematic cross-sectional view taken along a line XVI-XVI in FIG. 15. That is, FIG. 16 illustrates a cross section at gap position P₁ in the vertical direction. Thus, FIG. 16 is a schematic diagram for describing the void ratio. With reference to FIG. 16, the void ratio is a ratio of an area of a void region excluding the portion where the application needle (distal end 23) is placed to an area of a region surrounded by inner wall 21a (through-hole 22) of application liquid container 21 on a plane (paper surface on which FIG. 16 is given) in the horizontal direction at gap position P₁ described above. In other words, the void ratio is a ratio of an area of a region of a void 28 between the outermost portion of distal end 23 and the inner wall (through-hole 22) to an area of a region inside the portion (through-hole 22) in FIG. 16 corresponding to inner wall 21a in FIG. 15.

In the present working example, with a liquid material the same in viscosity as liquid material “C” having a viscosity of 13.10 Pa·s, the influence on the application interval when the void ratio is changed was examined. Note that the application interval is a time from immediately after the upward movement of application needle 24 after application to immediately before application needle 24 starts to move down to perform application again. The application interval was determined as a time required for comparing the first application diameter of the pattern applied in a first application process and a second application diameter of the pattern applied in a second application process immediately after the first application process and bringing a difference within 5% of the first application diameter.

Normally, when the application interval is shorter than the time during which liquid material 100 flows into the region adjacent to and immediately below the tip of application needle 24 in application liquid container 21, the application diameter tends to be small. The application interval when the void ratio is 80% was defined as a reference value of 1, and a change in the application interval when the void ratio is changed was calculated. The following Table 5 shows the calculation results. In Table 5, when the rate of change in the application interval with the void ratio of 80% is within 5% (that is, when the application interval is greater than or equal to 0.95 and less than or equal to 1.05), the application interval is described as 1 (no change).

TABLE 5

| Void ratio | Application interval (ratio) |
|---|---|
| 80% | 1 |
| 71% | 1 |
| 62% | 1 |
| 43% | 1.6 |
| 29% | 2.8 |

As shown in Table 5, the lower the void ratio, the longer the application interval. In other words, a lower void ratio indicates a lower position of application needle 24. This is because, with distal end 23 located at the same height as the uppermost portion of through-hole 22, when application needle 24 moves down, diameter Td of application needle 24 at the same height as the uppermost portion of through-hole 22 becomes larger. Therefore, when the initial position of application needle 24 is lowered to make the void ratio less than or equal to, for example, 43%, it is possible to reduce the number of air bubbles mixing in as shown in Table 4. This is because when the void ratio is less than or equal to 43%, the tip of application needle 24 is placed relatively downward in liquid material 100 at the initial position as compared with the case where the void ratio is 80%, and the application needle is sufficiently immersed in liquid material 100 accordingly. In this case, however, as shown in Table 5, the longer the application interval, the longer the takt time, which makes the use efficiency of the liquid material lower.

Therefore, from Table 5, application liquid container 21 is aligned over application object 5 of liquid material 100 before the application process (as illustrated in (A) of FIG. 8) so as to bring the application interval as close as possible to the reference value. At this time, it is more preferable that the initial position of application needle 24 be determined so as to minimize the void ratio within a void ratio range in which the application interval does not change relative to the reference value (even if the application interval changes relative to the reference value, the change falls within 5% of the reference value of the application interval when the void ratio is 80%). Specifically, in the aligning process as illustrated in (A) of FIG. 8, the initial position of application needle 24 is preferably determined to be a position where the void ratio is greater than or equal to 62% (60%). When the initial position of application needle 24 is lowered to the position where the void ratio is, for example, 62% (60%), application needle 24 is located lower than the initial position of application needle 24 where the void ratio is 80%. It is therefore more preferable that the initial position of application needle 24 be lowered to the position where the void ration is 62% (60%) because it is possible to reduce the number of air bubbles mixing in as shown in Table 4 and to suppress an increase in the application interval as shown in Table 5. Therefore, when the void ration is 62% (60%), it is possible to suppress the extension of the takt time of the application process while reducing the number of air bubbles mixing in. As described above, the use of the adjustment method by which the application interval is minimized as compared with the known empirical method allows an increase in the use efficiency of liquid material 100 and can minimize the application interval.

Note that, with application needle 24 having large tip diameter Pd, and high viscous liquid material 100 used, when application needle 24 is placed at the preferable initial position found in the present working example, air bubbles can be prevented, but the application interval may become longer. In this case, design factors such as the internal shape of application liquid container 21, diameter Hd of through-hole 22 of application liquid container 21, and the shape of application needle 24 may be optimized. As a result, the space in the vicinity of the tip of application needle 24 at the initial position may be designed to be larger to allow liquid material 100 to flow into the space in the vicinity of the tip of application needle 24 more easily. This allows an increase in the effect of making the takt time of the application process shorter without mixing air bubbles.

### Third Working Example

The second working example shows, with attention paid to gap position P₁, a method for preventing an increase in the application interval. However, when the application interval is made shorter, air bubbles may mix into liquid material 100 in application liquid container 21. FIG. 17 is a schematic diagram illustrating how air bubbles mix in in a manner that depends on the application interval. FIG. 17 illustrates changes over time in the order of (A), (B), and (C). With reference to FIG. 17, when application needle 24 is retracted into application liquid container 21, liquid material 100 flows into the region adjacent to the tip of application needle 24 in application liquid container 21. When, however, the application interval is short, application needle 24 enters application liquid container 21 while the region adjacent to the tip of application needle 24 is not sufficiently filled with liquid material 100. At this time, air in the region adjacent to the tip of application needle 24 that is not sufficiently filled with liquid material 100 is caught in liquid material 100. When such a problem occurs, it is considered preferable to increase the application interval.

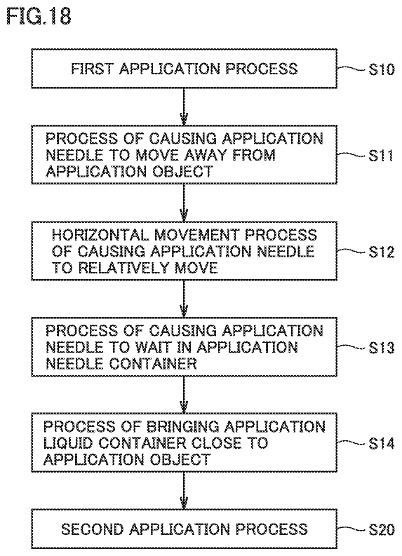

FIG. 18 is a flowchart of the liquid material application method according to the third working example. With reference to FIG. 18, in the present working example, the application process of causing application needle 24 to apply liquid material 100 is performed a plurality of times. That is, the application process includes the first application process (S10) of causing application needle 24 to apply liquid material 100, and the second application process (S20) of causing application needle 24 to apply liquid material 100 again immediately after the first application process.

Between the first application process (S10) and the second application process (S20), as illustrated in (F) of FIG. 8, application needle 24 moves up away from application object 5 (S11). This causes entire application needle 24 including the tip to be retracted into application liquid container 21. Application liquid container 21 may move up simultaneously with or immediately after the retraction, Immediately, after the retraction, a horizontal movement process of causing application needle 24 to relatively move in the horizontal direction to a position where liquid material 100 is to be applied in the second application process (S12). That is, application object 5 moves on, for example, X-axis table 1 and Y-axis table 2 (see FIG. 1) such that application object 5 to be applied next by application needle 24 is located immediately below liquid material application unit 4. Alternatively, application needle 24 may move in a direction along the XV plane to immediately above application object 5 to be applied next. This aligns application liquid container 21 over application object 5 of liquid material 100.

Furthermore, a wait process (S13) of causing application needle 24 to wait in application liquid container 21 is provided between the first application process (S10) and the second application process (S20). Specifically, a time during which application needle 24 waits in application liquid container 21 is a time during which the stage such as X-axis table 1 and application liquid container 21 do not move, application needle 24 does not move up or down relative to application liquid container 21, and application needle 24 remains stationary in application liquid container 21. In the present working example, for the process (S13), such a wait time of application needle 24 is provided. Subsequently, application liquid container 21 is brought close to application object 5 (S14). That is, for example, as illustrated in (B) of FIG. 8, application liquid container 21 moves down. Subsequently, application needle 24 moves down relative to application liquid container 21 as illustrated in (C) of FIG. 8, and distal end 23 of application needle 24 comes into contact with application object 5 as illustrated in (D) of FIG. 8. The second application process (S20) is performed as illustrated in (C), (D) of FIG. 8.

As described above, in the present working example, the wait process (S13) of causing application needle 24 to wait in application liquid container 21 is provided between the first application process (S10) and the second application process (S20) in addition to the processes (S11), (S12), (S14). The process (S13) may be performed temporally before or after the horizontal movement process (S12). The application interval in the present working example is obtained by adding the time of the wait process (S13) of causing application needle 24 to wait in application liquid container 21 to the application interval in the second working example. That is, the application interval in the present working example is a time from immediately after the upward movement of application needle 24 to retract entire application needle 24 into application liquid container 21 after the application in the first application process (S10) to immediately before application needle 24 starts to move down in the second application process (S20) after the horizontal movement process (S12) (including the upward movement of application liquid container 21), the wait process (S13), and the downward movement of application liquid container 21 (S14).

When the distance (pitch) in the horizontal direction between the application position in the first application process (S10) and the application position in the second application process (S20) is short, the adjustment method of the present working example is particularly effective. Further, the adjustment method of the present working example is also particularly effective when the movement time of the stage such as X-axis table 1 and Y-axis table 2 in the horizontal movement process (S12) is short.

Next, experiment details and results of the present working example will be described. Examinations were conducted, using liquid materials the same in viscosity as liquid material “A” having a viscosity of 0.45 Pa·s, liquid material “B” having a viscosity of 1.95 Pa·s, and liquid material “C” having a viscosity of 13.10 Pa·s, on air-bubble mixing ratios with the application interval variously changed. The change in the application interval was adjusted in accordance with the presence or absence of the wait process (S13) of causing application needle 24 to wait in application liquid container 21 and the change over time. The following Table 6 shows the test results.

TABLE 6

| | Application | | | Application | | | Application | | |
|---|---|---|---|---|---|---|---|---|---|
| | interval: | | | interval: | | | interval: | | |
| | 1 second | | | 3 seconds | | | 5 seconds | | |
| φ 1000 μm | A | B | C | A | B | C | A | B | C |
| Number of | 24 | 24 | 24 | 24 | 24 | 24 | 24 | 24 | 24 |
| samples | | | | | | | | | |
| Number of | 0 | 2 | 8 | 0 | 0 | 3 | 0 | 0 | 0 |
| mixing air | | | | | | | | | |
| bubbles | | | | | | | | | |
| Air-bubble | 0% | 8% | 33% | 0% | 0% | 13% | 0% | 0% | 0% |
| mixing ratio | | | | | | | | | |

As shown in Table 6, in the case of A that is low in viscosity, air bubbles did not mix in with the short application interval of 1 second (that is, in an example where the wait process (S13) of causing application needle 24 to wait in application liquid container 21 is not performed). However, in the case of the short application interval of 1 second, B that is high in viscosity was higher in air-bubble mixing ratio than A. C that is further higher in viscosity was higher air-bubble mixing ratio than B. It can be presumed that, since A was low in viscosity, liquid material 100 easily flowed, and liquid material 100 filled the region immediately below the tip of application needle 24 immediately after application needle 24 was retracted into application liquid container 21, thereby preventing air bubbles from mixing in. Even with B, C that are high in viscosity, however, an increase in the application interval and providing the wait process (S13) made the air-bubble mixing ratio lower. When the application interval was 3 seconds, the air-bubble mixing ratio was 13% with C that is the highest in viscosity, whereas when the application interval was 5 seconds, the air-bubble mixing ratio was 0% even with C. Note that the wait time of application needle 24 with the application interval of 3 seconds was 2 seconds. The wait time of application needle 24 with the application interval of 5 seconds was 4 seconds. This shows that higher viscosity requires a longer application interval (wait time of application needle 24 in the process (S13)) to prevent air bubbles from mixing in.

Note that polymer solutions as liquid material 100 have complicated flow characteristics depending on types, and have different fluid behavior depending on the presence or absence of thixotropy and stringiness even with the same viscosity. When the application interval is set, it is preferable that the application interval be set on the basis of the test results of Table 6 with due consideration given to the flow characteristics of liquid material 100 to be used.

The features described in each example included in the embodiment and each working example may be appropriately combined and applied within a range where there is no technical contradiction. For example, the features derived in the second working example and the features derived in the third working example may be combined. The features included in the present embodiment may be applied to each of the first to third working examples.

It should be understood that the embodiments disclosed herein are illustrative in all respects and not restrictive. The scope of the present invention is defined by the claims rather than the above description, and the present invention is intended to include the claims, equivalents of the claims, and all modifications within the scope.

### REFERENCE SIGNS LIST

1: X-axis table, 2: Y-axis table, 3: Z-axis table, 4: liquid material application unit, 5: application object, 6: observation optical system, 7: CCD camera, 8: control panel, 9: monitor, 10: control computer, 11: controller, 12: base, 21: application liquid container, 21a: inner wall, 22: through-hole, 23: distal end, 24: application needle, 24a: uniform width region, 25: joining section, 26: needle movement section, 27: C surface, 28: void, 100: liquid material, 102: application needle holder, 104: application needle holder housing, 106: application needle holder fixing section. 108: movable section, 110: coupling shaft, 112: coupling plate, 114: eccentric shaft, 116: eccentric plate, 118: origin sensor, 120: servomotor, 121: motor driver, 122, 124: bearing, 126: spring, 128, 128A, 128B: fixing pin, 130: linear motion mechanism, 132: linear guide, 143: cam, 145: cam coupling plate, 161: cam surface, 162: upper end flat region, 163: lower end flat region, 200: liquid material application device

1. A liquid material application unit comprising:
an application needle that applies a liquid material; and
an application liquid container that holds therein the liquid material and has a through-hole formed at a bottom portion, the through-hole allowing the application needle to pass through, wherein
the application liquid container includes a joining section extending in a horizontal direction intersecting an extending direction of the application needle, and a needle movement section extending from the joining section to the through-hole in a vertical direction that coincides with the extending direction of the application needle,
a protrusion amount by which the application needle is allowed to protrude from the through-hole of the application liquid container in the vertical direction is greater than or equal to 1 mm and less than or equal to 3 mm,
a first width of the needle movement section in the horizontal direction is less than or equal to 5 mm, and
a length of the needle movement section extending from the joining section to the through-hole in the vertical direction is greater than or equal to 5 mm.

2. The liquid material application unit according to claim 1, wherein the first width is less than or equal to five times a second width, in the horizontal direction, of a portion of the application needle extending in the vertical direction.

3. A liquid material application device comprising the liquid material application unit according to claim 1.

4. A liquid material application method comprising:
an aligning process of aligning an application liquid container having a through-hole formed at a bottom portion over an application object of a liquid material with the liquid material held in the application liquid container and a distal end of an application needle immersed in the liquid material;
an approaching process of bringing the application liquid container close to the application object; and
an application process of applying the liquid material to the application object by moving the application needle in an extending direction of the application needle, wherein
in the application process, a protrusion amount by which the application needle is allowed to protrude from the through-hole of the application liquid container in the extending direction is greater than or equal to 1 mm and less than or equal to 3 mm, and
in the approaching process, the application liquid container is placed to be at least partly surrounded by the application object.

5. The liquid material application method according to claim 4, wherein
a void ratio indicating a ratio of an area of a region excluding a portion where the application needle is placed to an area of a region surrounded by an inner wall of the application liquid container on a plane extending in a horizontal direction intersecting the extending direction of the application needle is defined at a gap position where a distance between the application needle and the inner wall in the horizontal direction is shortest, and
in the aligning process, the application needle is placed so as to make a position of the distal end of the application needle in the extending direction coincident with a position where the void ratio is greater than or equal to 60%.

6. The liquid material application method according to claim 4, wherein viscosity of the liquid material is less than or equal to 13.10 Pa·s.

7. The liquid material application method according to claim 4, wherein in the application process, movement of the application needle toward the application object and movement of the application needle away from the application object in the extending direction are repeated nine times or less per second.

8. The liquid material application method according to claim 4, wherein
the application process includes a first application process of causing the application needle to apply the liquid material, and a second application process of causing the application needle to apply the liquid material immediately after the first application process, and
between the first application process and the second application process, a horizontal movement process of causing the application needle to relatively move in a horizontal direction intersecting the extending direction to a position where the liquid material is to be applied in the second application process, a wait process of causing the application needle to wait in the application liquid container, and the approaching process are performed.

9. The liquid material application method according to claim 4, wherein the liquid material is a liquid having fine particles suspended therein.
